(19) United States
(12) Patent Application Publication
(10) Pub. No.: US 2026/0147640 A1
(43) Pub. Date: May 28, 2026

(54) TASK EXECUTION THROUGHPUT

(71) Applicant: NVIDIA Corporation, Santa Clara, CA (US)

(72) Inventors: Gentaro Hirota, San Jose, CA (US); Haldun Umur Darbaz, Santa Clara, CA (US); Naman Govil, San Francisco, CA (US); Chen Mei, Shanghai (CN); Shayani Deb, Seattle, WA (US)

(21) Appl. No.: 18/959,490

(22) Filed: Nov. 25, 2024

(51) Int. Cl. G06F 9/52; G06F 9/48

(52) U.S. Cl. CPC G06F 9/52; G06F 9/4881

(57) ABSTRACT

Disclosed are systems and techniques for improved task execution throughput by a processor. The techniques include executing, by a processing unit, a first task with associated processor configuration requirements. The techniques further include receiving a second task and a third task to be executed by the processing unit. Each of the second task and the third task has associated processor configuration requirements. The techniques further include determining a first next task to execute by the processing unit based on a comparison of a current processor configuration of the processing unit with the processor configuration requirements of the second task and the third task. The current processor configuration of the processing unit is based on the processor configuration requirements associated with the first task. The techniques further include providing the first next task to the processing unit for execution.

### TECHNICAL FIELD

At least one embodiment pertains to dispatching tasks for execution by a processor, and more specifically, to dispatching task for execution in an order different than the order in which the tasks were received.

### BACKGROUND

Processors (e.g., central processing units (CPUs), graphics processing units (GPUs)) can execute tasks from multiple processes concurrently. Tasks can have an associated priority and can be executed based on their priority. Before execution, the tasks can be loaded from memory and stored in a scheduling table, which can have limited space (e.g., due to hardware constraints). An in-memory task descriptor can be used to track the tasks (e.g., to be able to suspend a running task and resume the next task selected to run based on priority) while they are in the scheduling table. The in-memory task descriptor can contain task state associated with a task, such as processor configuration requirements, resource requirements, a program/shader associated with the task, and/or the like.

### BRIEF DESCRIPTION OF THE DRAWINGS

FIG. 1 is a block diagram of an example system for improved processor throughput, according to at least one embodiment.

FIG. 2A is a block diagram of an example efficient dispatch scheduling table, according to at least one embodiment.

FIG. 2B is a block diagram of an example efficient dispatch scheduling table, according to at least one embodiment.

FIG. 3 is a flow diagram of an example method for efficient dispatch of task for execution by a processor, according to at least one embodiment.

FIG. 4 is a block diagram illustrating an exemplary computer system, in accordance with at least one embodiment of the present disclosure.

FIG. 5A illustrates inference and/or training logic, according to at least one embodiment of the present disclosure.

FIG. 5B illustrates inference and/or training logic, according to at least one embodiment.

FIG. 6 illustrates training and deployment of a neural network, according to at least one embodiment.

FIG. 7 is an example data flow diagram for an advanced computing pipeline, according to at least one embodiment.

FIG. 8 is a system diagram for an example system for training, adapting, instantiating and deploying machine learning models in an advanced computing pipeline, according to at least one embodiment.

### DETAILED DESCRIPTION

Often, tasks are executed in the order they are received. For example, a processor scheduler may receive (e.g., load) multiple tasks from memory into a scheduling table. The tasks may be dispatched for execution by one or more processors in the order the tasks were loaded into the table. As discussed above, each task can have its own processor configuration requirements, resource requirements, and/or associated program/shader (e.g., a shader program or script).

Processor configuration requirements can include one or more properties of a processor that may be set in order for the task to be executed by the processor. In some embodiments, processor configuration requirements can include a level 1 (L1) cache memory configuration. For example, the processor configuration requirements can specify how much tagged (or untagged) L1 memory is required for executing a particular task.

To execute a first task with first processor configuration requirements, a processor can be reconfigured to match the first processor configuration requirements. For example, a memory of the processor can be modified to match the memory configuration in the processor configuration requirements. After execution of the first task, if a second task has second processor configuration requirements that are different than the first processor configuration requirements, the processor can be reconfigured again, this time to match the second processor configuration requirements. Frequent processor reconfiguration can reduce a throughput of the processor.

Additionally, before dispatching a task from the scheduling table to a processor for execution, the processor must be queried to determine resource availability of the processor. For example, a task may have 5 threads (or thread blocks or cooperative thread arrays (CTAs)) to be executed. After querying a processor, it may be determined that the processor has resources available to execute 3 threads (or thread blocks or CTAs). Thus, 3 of the 5 threads of the task can be dispatched to the processor for execution. After those threads complete, the processor can be queried again to determine a new resource availability of the processor. If there are sufficient resources available to execute the remaining 2 threads of the task, the 2 threads can be dispatched for execution by the processor. Frequent processor querying to determine resource availability can also reduce the throughput of the processor.

Aspects of the present disclosure address the above and other deficiencies by providing for systems and techniques that execute tasks in an order different than the order in which the tasks were received. More specifically, the techniques dispatch tasks for execution based on the task's associated processor configuration, resource requirements, and/or program/shader (e.g., shader program or script). To improve an execution throughput of a processor, tasks can be dispatched from a scheduling table in such a way as to minimize processor reconfiguration and processor resource availability querying. For example, if a first, second, and third task were loaded into a scheduling table in that order, and the first and third task had the same processor configuration requirements, the third task may be scheduled after the first task finishes execution to avoid reconfiguring the processor between the first task and the third task. After the third task finishes execution, the processor can be reconfigured to execute the second task.

In another example, a first and second task may be loaded into a scheduling table, and the tasks may have the same processor configuration requirements. A processor may currently be executing a task that has the same processor configuration requirements as the first task and the second task in the scheduling table. Before executing the current task, the processor may have been queried to determine its resource availability. If the processor had resource availability for 5 threads and the currently executing task only used 3 threads, 2 threads of another task with resource requirements that match the currently executing task can be dispatched for execution without querying the processor again. In some cases, a “thread” can represent a group of threads, such as a thread block or a cooperative thread array (CTA).

Continuing the previous example, the second task in the scheduling table may have resource requirements that match the currently executing task, while the first task in the scheduling table has different resource requirements than the currently executing task. 2 threads of the second task can be dispatched for execution by the processor without querying the processor for its resource availability. After the second task finishes execution, the processor can again be queried for its resource availability before executing the first task from the scheduling table.

If the scheduling table has tasks that have the same processor configuration requirements and resource requirements as the currently executing task of a processor, a next task can be determined based on a program/shader of the task and the program/shader of the currently executing task. For example, if a task in the scheduling table has the same program/shader as the currently executing task, the task from the scheduling table can be dispatched to the processor next to take advantage of instruction cache hits, further reducing the time required to execute the task and increasing the throughput of the processor.

Advantages of the disclosed embodiments over the existing technology include but are not limited to an increased task execution throughput of a processor.

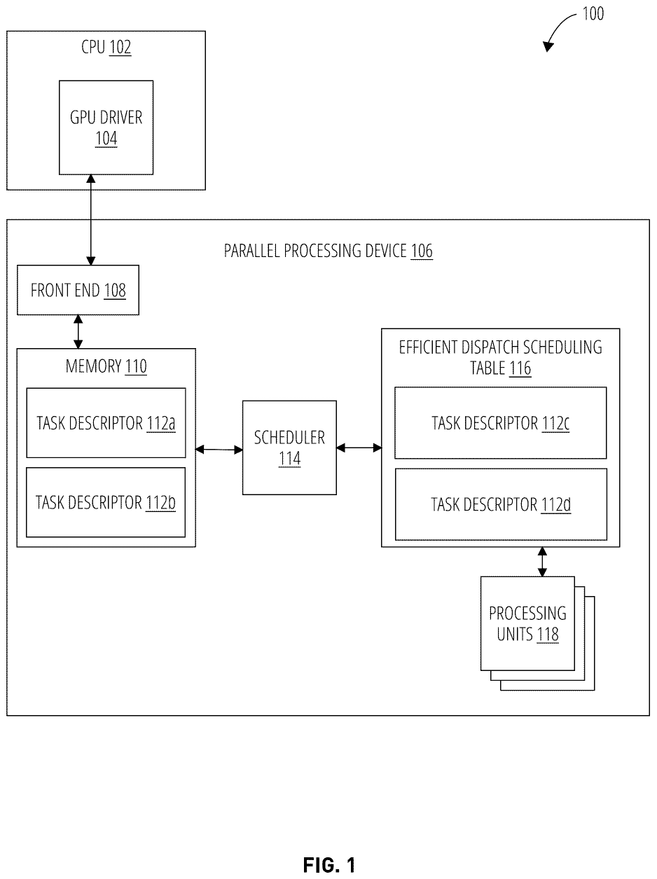

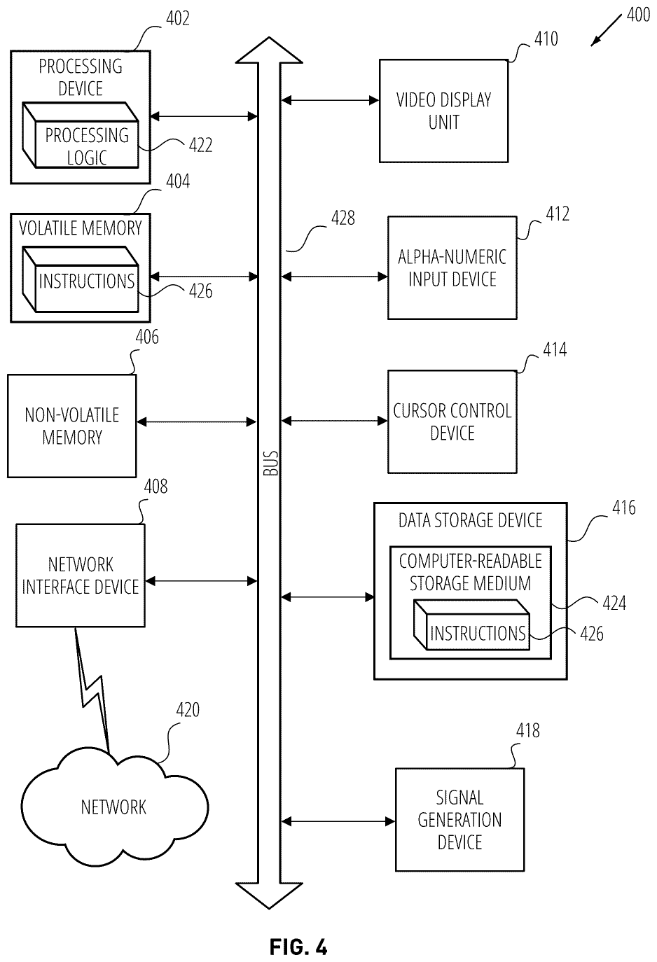

FIG. 1 is a block diagram of an example system 100 for improved processor throughput, according to at least one embodiment. System 100 can include a central processing unit (CPU) 102 and a parallel processing device 106 (e.g., a graphics processing unit (GPU)). In some embodiments, CPU 102 and parallel processing device 106 can be included within another system (e.g., computer system 400 of FIG. 4). For example, system 100 can be comprised within a desktop computer, a server, a laptop, a mobile device, and/or the like. In some embodiments, parallel processing device 106 can be used to perform machine learning and/or artificial intelligence (AI) tasks. For example, parallel processing device 106 can be used for training AI models, performing inferencing using trained AI models, and/or the like.

CPU 102 can include GPU driver 104 for interfacing with parallel processing device 106. CPU 102 can send via GPU driver 104 one or more tasks descriptors to parallel processing device 106 for execution. Each task descriptor can include information related to its execution, such as processor configuration requirements, resource requirements, a program/shader of the task descriptor, and/or the like.

Processor configuration requirements can include one or more properties of a processor that may be set in order for the task corresponding to the task descriptor to be executed by the processor. In some embodiments, processor configuration requirements of a task descriptor can include a level 1 (L1) cache memory configuration. For example, the processor configuration requirements can specify how much tagged (or untagged) L1 memory is required for executing the task corresponding to the task descriptor.

Resource requirements can include one or more resources of a processor that the task corresponding to the task descriptor requires for execution. In some embodiments, resource requirements of a task descriptor can include one or more of a thread block size of the task corresponding to the task descriptor, a number of registers needed by the task, or a number of barriers needed by the task.

The program/shader of the task descriptor can include one or more addresses that may be accessed by the processor during execution of the task descriptor. For example, the program/shader of the task descriptor can include a first address of a region of instructions that may be executed by the processor during execution of the task descriptor.

Parallel processing device 106 can include front end 108, memory 110, scheduler 114, efficient dispatch scheduling table 116, and one or more processing units 118. Processing units 118 can include one or more processing units for performing parallel processing (e.g., parallel processing units). Front end 108 can interface with CPU 102 via GPU driver 104. Front end 108 can receive one or more task descriptors from CPU 102 that are to be executed by parallel processing device 106 (e.g., by processing units 118) and save them in memory 110.

For example, memory 110 can include task descriptor 112a and task descriptor 112b. Task descriptor 112a and task descriptor 112b can each include processor configuration requirements, resource requirements, and/or a program/shader. Task descriptor 112a can have the same (or different) processor configuration requirements, resource requirements, and/or program/shader as task descriptor 112b.

Scheduler 114 can read task descriptors from memory 110 and load them into efficient dispatch scheduling table 116. Efficient dispatch scheduling table 116 can have limited storage space (e.g., due to hardware constraints). Task descriptors can be stored in efficient dispatch scheduling table 116 after being loaded from memory 110 and during execution by processing units 118.

Efficient dispatch scheduling table 116 can include one or more task descriptors (e.g., task descriptor 112c, task descriptor 112d, etc.). Efficient dispatch scheduling table 116 can launch task descriptors for execution by one or more processing units 118. During execution of a task descriptor, the state of the task descriptor in efficient dispatch scheduling table 116 can be updated. For example, as a task descriptor is executed, a task state (e.g., raster state, shader state, etc.) of the task descriptor can be updated.

Deploying task descriptors from efficient dispatch scheduling table 116 to processing units 118 can occur quickly and with minimal overhead (e.g., without accessing memory 110). To maintain high utilization of processing units 118, and thus increase an overall throughput of processing units 118, task descriptors can be selected for execution from efficient dispatch scheduling table 116 based on one or more properties of the task descriptors and a current state of the one or more processing units 118.

As discussed above, the processor configuration requirements of a task descriptor includes properties of a processor (e.g., processing unit) that can be set before the task descriptor can be executed. Before a task descriptor with a first set of processor configuration requirements can be executed, the processor may be configured to match the first set of processor configuration requirements. Then, the task descriptor can be executed. Other task descriptors that have the same processor configuration requirements can execute concurrently on the processor.

To execute another task descriptor with a second set of processor configuration requirements, the processor may be drained (e.g., all running processes on the processor allowed to finish so the processor reaches an idle state) and reconfigured to match the second set of processor configuration requirements.

To avoid the overhead of letting the processor drain and reconfigure before executing a subsequent task descriptor, task descriptors in efficient dispatch scheduling table 116 can be selected that match the current processor configuration of a processor. If a task descriptor has processor configuration requirements that match a current configuration of a processor, that task descriptor can be selected for execution next, even if one or more task descriptors were loaded into efficient dispatch scheduling table 116 before that task descriptor.

If there are multiple task descriptors that have the same processor configuration requirements, task descriptor resource requirements can be an additional criterion used for selecting the next task to provide to processing units 118 for execution. For example, task descriptors that have resource requirements that match the resource requirements of a currently-executing task can be selected as the next task for execution, even if one or more task descriptors were loaded into efficient dispatch scheduling table 116 before that task descriptor.

Before a task descriptor can be dispatched to a processor for execution, the processor must be queried to determine if it has sufficient resources to execute the task descriptor. The processor can respond to the query with an amount of available resources. If there are sufficient resources to execute a task descriptor, the task descriptor can be provided to the processor for execution. In some cases, the task descriptor does not use all available resources of the processor during execution. For example, the processor may respond to the query indicating that 8 resources (e.g., registers, barriers, thread block slots, etc.) are available. The task descriptor may only use 3 of the resources, leaving 5 additional resources available. If another task descriptor in efficient dispatch scheduling table 116 has the same resource requirements as the currently executing task (and the same processor configuration requirements, as discussed above), that next task descriptor can be provided to the processor for execution without requiring an additional query, since it is known that 5 resources are available and the next task descriptor requires less than that. By selecting next task descriptors based on their shared resource requirements, round-trip time related to querying a processor can be eliminated, leading to lower task descriptor dispatch latencies and higher processor throughput.

In some embodiments, a next task descriptor can be selected based on sharing a program/shader with a currently executing task. For example, if a processor is executing a first task descriptor with a first program/shader, and efficient dispatch scheduling table 116 has a second task descriptor with a second program/shader and a third task descriptor with a program/shader that matches the first program/shader, the third task descriptor can be identified as the next task descriptor to be provided to the processor to be executed. Because the first task descriptor and the third task descriptor share a program/shader, the instruction cache of the processor is more likely to have cache hits while executing the third task descriptor, resulting in reduced execution time of the task descriptor and higher processor throughput.

In some embodiments, a processing device (e.g., parallel processing device 106) can have more than one processor (e.g., processing units 118). Each processor can have its own configuration and resource availability. In some embodiments, tasks from efficient dispatch scheduling table 116 with a first processor configuration can be executed by a first processor, and tasks from efficient dispatch scheduling table 116 with a second processor configuration can be executed by a second processor. In some embodiments, a first processor and a second processor can have the same processor configuration, and each of the processors can be queried to determine their current resource availability. A task descriptor can be selected for execution from efficient dispatch scheduling table 116 based on the current resource availability of one of the processors. If none of the processors of the processing device has a processor configuration that matches the processor configuration requirements of the task descriptors in efficient dispatch scheduling table 116, one of the processors of the processing device can be drained and reconfigured while the other processors continue execution of task descriptors.

In some embodiments, task descriptors are loaded from memory 110 as they complete execution and are removed from efficient dispatch scheduling table 116. In some embodiments, task descriptors are loaded from memory 110 when efficient dispatch scheduling table 116 reaches an occupancy threshold (e.g., 90% full, 80% full, 50% full, 10% full, etc.). In some embodiments, task descriptors are loaded from memory 110 when efficient dispatch scheduling table 116 is empty.

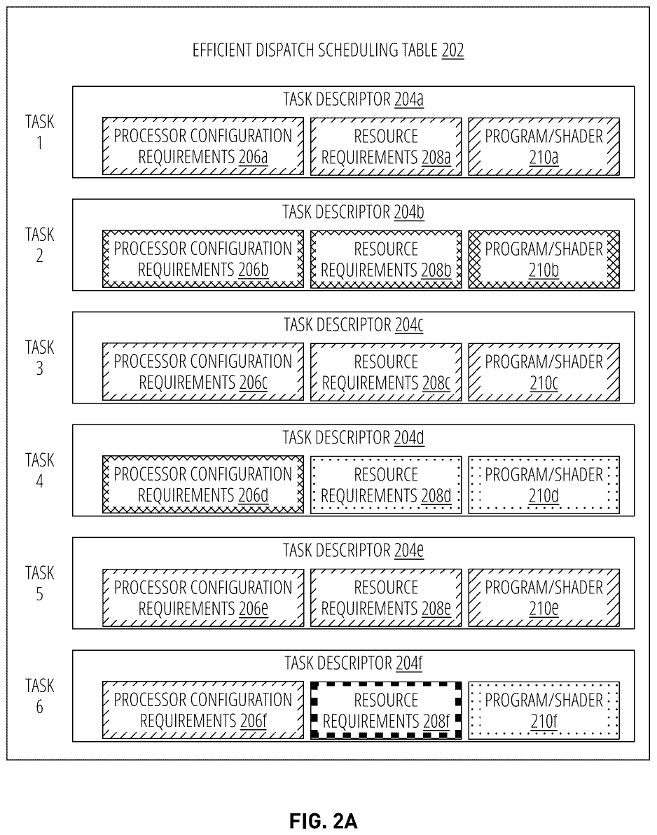

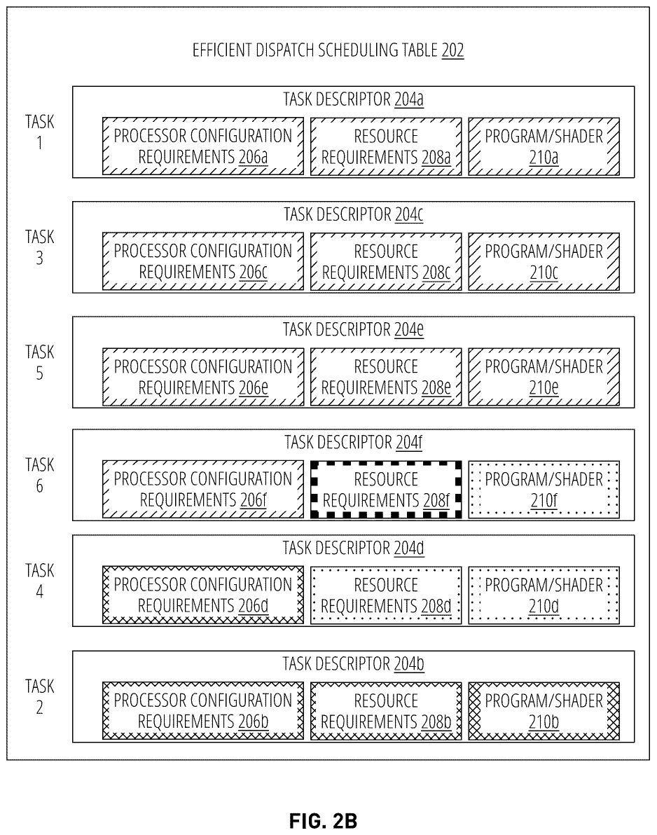

FIG. 2A is a block diagram of an example efficient dispatch scheduling table 202, according to at least one embodiment. Efficient dispatch scheduling table 202 can include one or more task descriptors (e.g., task descriptor 204a, task descriptor 204b, task descriptor 204c, task descriptor 204d, task descriptor 204e, task descriptor 204f, etc.). Each task descriptor can include processor configuration requirements (e.g., 206a, 206b, 206c, 206d, 206e, 206f, etc.), resource requirements (e.g., 208a, 208b, 208c, 208d, 208e, 208f, etc.), and/or a program/shader (e.g., 210a, 210b, 210c, 210d, 210e, 210f, etc.). The task descriptors of efficient dispatch scheduling table 202 are labelled from task 1 through task 6. In FIG. 2A, the task descriptor labels are in ascending order from top to bottom, which can indicate that task 1 was loaded from memory into efficient dispatch scheduling table 202 first, then task 2, then task 3, and so on.

Elements of the same type in FIG. 2A that have the same shading (e.g., diagonal lines, hash lines, dots, checkerboard, etc.) may have the same values. For example, FIG. 2A may depict task descriptors with two different processor configuration requirements. A first group of task descriptors (e.g., 204a, 204c, 204e, and 204f) may have a first set of processor configuration requirements indicated with diagonal shading. A second group of task descriptors (e.g., 204b and 204d) may have a second set of processor configuration requirements indicated with hashed shading.

FIG. 2A may also depict task descriptors with four different resource requirements. A first group of task descriptors (e.g., 204a, 204c, and 204e) may have a first set of resource requirements indicated with diagonal shading. A second group of task descriptors (e.g., 204b) may have a second set of resource requirements indicated with hash shading. A third group of task descriptors (e.g., 204d) may have a third set of resource requirements indicated with dots shading. A fourth group of task descriptors (e.g., 204f) may have a fourth set of resource requirements indicated with checkerboard shading.

FIG. 2A may also depict task descriptors with three different programs/shaders. A first group of task descriptors (e.g., 204a, 204c, and 204e) may have a first program/shader indicated with diagonal shading. A second group of task descriptors (e.g., 204b) may have a second program/shader indicated with hash shading. A third group of task descriptors (e.g., 204d and 204f) may have a third program/shader indicated with dots shading.

In some embodiments, processor configuration requirements and/or resource requirements are stored as one or more integer and/or bitstream representations. For example, a first set of processor configuration requirements may be represented by a first integer and/or bitstream representation while a second set of processor configuration requirements may be represented by a second integer and/or bitstream representation. Resource requirements may be similar. In some embodiments, resource requirements include a plurality of integer and/or bitstream representations. For example, resource requirements may include a first integer value representing a number of registers required for task execution and a second integer value representing a number of barriers needed for task execution.

FIG. 2B is a block diagram of an example efficient dispatch scheduling table 202 according to at least one embodiment. FIG. 2B may depict the same task descriptors as FIG. 2A. However, in FIG. 2B, the task descriptor have been rearranged to show an efficient execution order of the task descriptors from top to bottom. In some embodiments, the first task descriptor to be executed is the first task descriptor loaded into memory. In some embodiments, the first task descriptor to be executed can be selected randomly (or according to another method) from the task descriptors in efficient dispatch scheduling table 202.

For example, a first task descriptor to be executed by a processor can be the first task descriptor in efficient dispatch scheduling table 202 (e.g., task descriptor 204a). Prior to execution, the processor can be drained and reconfigured to match the processor configuration requirements of the first task descriptor (e.g., processor configuration requirements 206a). The processor can also be queried to make sure that the processor has sufficient resources available to satisfy the resource requirements of the first task descriptor (e.g., resource requirements 208a).

After task descriptor 204a has been provided to the processor for execution, the next task descriptor to be executed can be determined. Task descriptors that share processor configuration requirements with task descriptor 204a can be determined: task descriptor 204c, task descriptor 204e, and task descriptor 204f. Of those task descriptors, task descriptors that share resource requirements with task descriptor 204a can be determined: task descriptor 204c and task descriptor 204e. Of those task descriptors, task descriptors that share a program/shader with task descriptor 204a can be determined: task descriptor 204c and task descriptor 204e. The next task descriptor can be selected from that group (e.g., randomly, based on the order they were loaded from memory, etc.). In this example, task descriptor 204c can be provided to the processor for execution next.

Because task descriptor 204a and task descriptor 204c share processor configuration requirements, the task descriptors can execute concurrently on the processor. Because task descriptor 204a and task descriptor 204c share resource requirements, the amount of resources available for executing task descriptor 204c can be determined without querying the processor. If the determined amount of resources available for executing task descriptor 204c is sufficient to execute task descriptor 204c, task descriptor 204c can be provided to the processor for execution without querying the processor. If the determined amount of resources available for executing task descriptor 204c is not sufficient to execute task descriptor 204c, the processor can be queried to get its current resource availability, then task descriptor 204c can be executed once resources are available.

After task descriptor 204c has been provided to the processor for execution, the next task descriptor to be executed can be determined. Task descriptors that share processor configuration requirements with task descriptor 204c can be determined: task descriptor 204e and task descriptor 204f. Of those task descriptors, task descriptors that share resource requirements with task descriptor 204c can be determined: task descriptor 204e. As task descriptor 204e is the only task descriptor in that group, it can be selected as the next task descriptor to be executed, regardless of its program/shader.

Because task descriptor 204c and task descriptor 204e share processor configuration requirements, the task descriptors can execute concurrently on the processor, so long as the processor has resources available.

After task descriptor 204e has been provided to the processor for execution, the next task descriptor to be executed can be determined. Task descriptors that share processor configuration requirements with task descriptor 204e can be determined: task descriptor 204f. As task descriptor 204f is the only task descriptor in that group, it can be selected as the next task descriptor to be executed, regardless of its resource requirements or program/shader.

Because task descriptor 204e and task descriptor 204f do not share resource requirements, the processor may be queried to obtain its resource availability before task descriptor 204f is provided for execution. If the processor has sufficient resources available, task descriptor 204f can be provided for execution.

After task descriptor 204f has been provided to the processor for execution, the next task descriptor to be executed can be determined. Since no more task descriptors have processor configuration requirements that match task descriptor 204f, task descriptors with other processor configuration requirements can be determined: task descriptor 204d and task descriptor 204b. In some embodiments, priority is given to task descriptors that have the most common processor configuration requirements in efficient dispatch scheduling table 202. For example, if there are 5 task descriptors left in efficient dispatch scheduling table 202 and 3 of them have a first set of processor configuration requirements and 2 of them have a second set of processor configuration requirements, a task descriptor from the group of 3 may be selected as the next task descriptor to provide for execution. In some embodiments, a next task descriptor can be selected randomly.

In this example, task descriptor 204d is selected as the next task descriptor to be provided for execution. Because task descriptor 204d has different processor configuration requirements than task descriptor 204f, the processor may be drained (e.g., wait for task descriptor 204f to finish execution so the processor is idle), and reconfigured from the previous processor configuration (e.g., based on 206a, 206c, 206e, and 206f) to the new processor configuration (e.g., based on 206d). The processor can then be queried to determine its available resources. After the processor is drained, reconfigured, and queried, task descriptor 204d can be provided to the processor for execution.

After task descriptor 204d has been provided to the processor for execution, the next task descriptor to be executed can be determined using a process similar to before. In this example, task descriptor 204b may be selected as the next task descriptor to provide to the processor as it is the final task descriptor in efficient dispatch scheduling table 202.

Since task descriptor 204b shares processor configuration requirements with task descriptor 204d, it can be executed concurrently with task descriptor 204d so long as there are available resources. However, because resource requirements 208b are different than resource requirements 208b, the processor may be queried to determine if there are resources available before providing task descriptor 204b for execution.

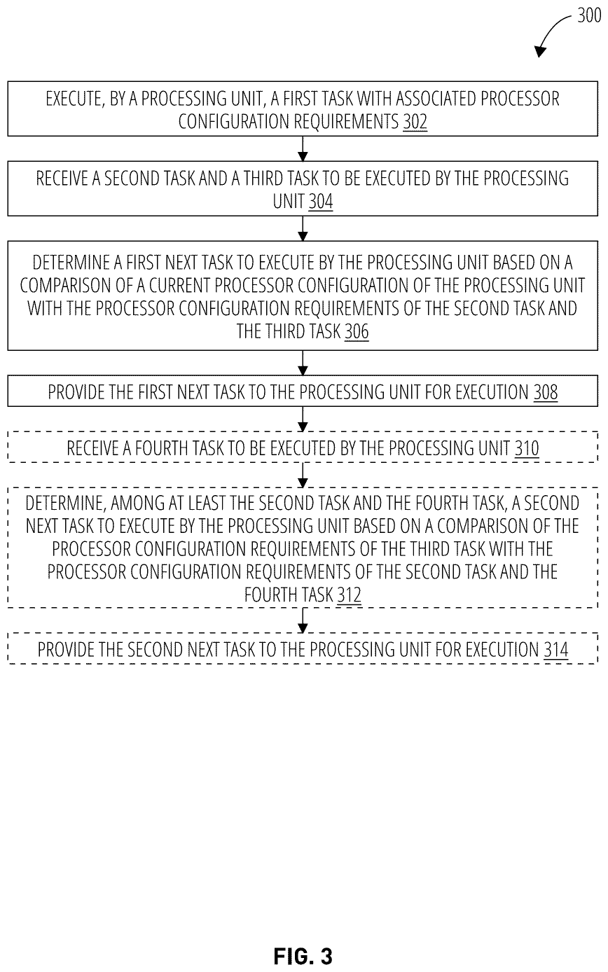

FIG. 3 is a flow diagram of an example method 300 for efficient dispatch of task for execution by a processor, according to at least one embodiment.

Method 300 can be performed using one or more processing units (e.g., CPUs, GPUs, accelerators, parallel processing units, physics processing units (PPUs), data processing units (DPUs), etc.), which may include (or communicate with) one or more memory devices. In at least one embodiment, method 300 can be performed using a processing device or processing devices. In at least one embodiment, method 300 can be performed using processing units of system 100 of FIG. 1. In at least one embodiment, method 300 can be performed by parallel processing device 106 of FIG. 1. In at least one embodiment, processing units performing method 300 can be executing instructions stored on a non-transient computer readable storage media. In at least one embodiment, method 300 can be performed using multiple processing threads (e.g., CPU threads and/or GPU threads), individual threads executing one or more individual functions, routines, subroutines, or operations of the method. In at least one embodiment, processing threads implementing method 300 can be synchronized (e.g., using semaphores, critical sections, and/or other thread synchronization mechanisms). Alternatively, processing threads implementing method 300 can be executed asynchronously with respect to each other. Various operations of method 300 can be performed in a different order compared with the order shown in FIG. 3. Some operations of method 300 can be performed concurrently with other operations. In at least one embodiment, one or more operations shown in FIG. 3 may not always be performed.

At block 302, processing units executing method 300 can execute, by a processing unit, a first task with associated processor configuration requirements. In some embodiments, the processor configuration requirements of the first task can include a level 1 (L1) cache memory configuration.

At block 304, processing units can receive a second task and a third task to be executed by the processing unit. Each of the second task and the third task can have associated processor configuration requirements.

At block 306, processing units can determine a first next task to execute by the processing unit based on a comparison of a current processor configuration of the processing unit with the processor configuration requirements of the second task and the third task. The current processor configuration of the processing unit can be based on the processor configuration requirements associated with the first task (e.g., the task currently being executed by the processing unit).

In some embodiments, each of the second task and the third task has associated resource requirements. In some embodiments, the resource requirements of the second task include at least one of a thread block size of the second task, a number of registers needed by the second task, or a number of barriers needed by the second task.

Determining the next task to execute by the processing unit can be further based on current resource availability of the processing unit and the resource requirements of the second task and the third task. For example, the current resource availability of the processing unit may have been determined before the first task started being executed by the processing unit. If the first task does not use all of the available resources of the processing unit, the next task can be provided to the processing unit for execution without further querying the processing unit, so long as the resource requirements of the first task are the same as the resource requirements of the next task (e.g., the second task or the third task).

In some embodiments, each of the second task and the third task has an associated program/shader. Determining the next task to execute by the processing unit can be further based on a current program/shader of the processing unit and the program/shader of the second task and the third task. For example, if the third task and the first task (e.g., the task currently executing on the processing unit) share a program/shader, the third task can be selected as the next task over the second task in order to improve task execution performance (e.g., by increasing instruction cache hits).

At block 308, processing units can provide the first next task to the processing unit for execution.

In some embodiments, the second task is received before the third task, and the first next task is the third task. Thus, the tasks can be provided to the processing unit for execution in an order different than the order in which the tasks were received.

In some embodiments, at block 310, processing units executing method 300 can receive a fourth task to be executed by the processing unit. The fourth task can have associated processor configuration requirements. At block 312, processing units can determine, among at least the second task and the fourth task, a second next task to execute by the processing unit based on a comparison of the processor configuration requirements of the third task (e.g., the task currently being executed by the processing unit) with the processor configuration requirements of the second task and the fourth task. At block 314, processing units can provide the second next task to the processing unit for execution.

FIG. 4 is a block diagram illustrating an exemplary computer system, in accordance with at least one embodiment of the present disclosure. In some embodiments, the computer system 400 can comprise system 100 of FIG. 1. Computer system 400 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 416, which communicate with each other via a bus 428.

Processor (processing device) 402 represents one or more general-purpose processing devices such as a microprocessor, central processing unit, or the like, and may include processing logic 422. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 is configured to execute instructions 426 (e.g., for generating threat indicator alerts) for performing the operations discussed herein.

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 418 (e.g., a speaker). In some embodiments, computer system 400 may not include video display unit 410, input device 412, and/or cursor control device 414 (e.g., in a headless configuration).

The data storage device 416 can include a non-transitory machine-readable storage medium 424 (also computer-readable storage medium) on which is stored one or more sets of instructions 426 (e.g., for efficient dispatch of task for execution by a processor) embodying any one or more of the methodologies or functions described herein. The instructions 426 can also reside, completely or at least partially, within the main memory 404 and/or within the processor 402 during execution thereof by the computer system 400, the main memory 404 and the processor 402 also constituting machine-readable storage media. The instructions can further be transmitted or received over a network 420 via the network interface device 408.

In one implementation, the instructions 426 include instructions for efficient dispatch of task for execution by a processor. While the computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

### Inference and Training Logic

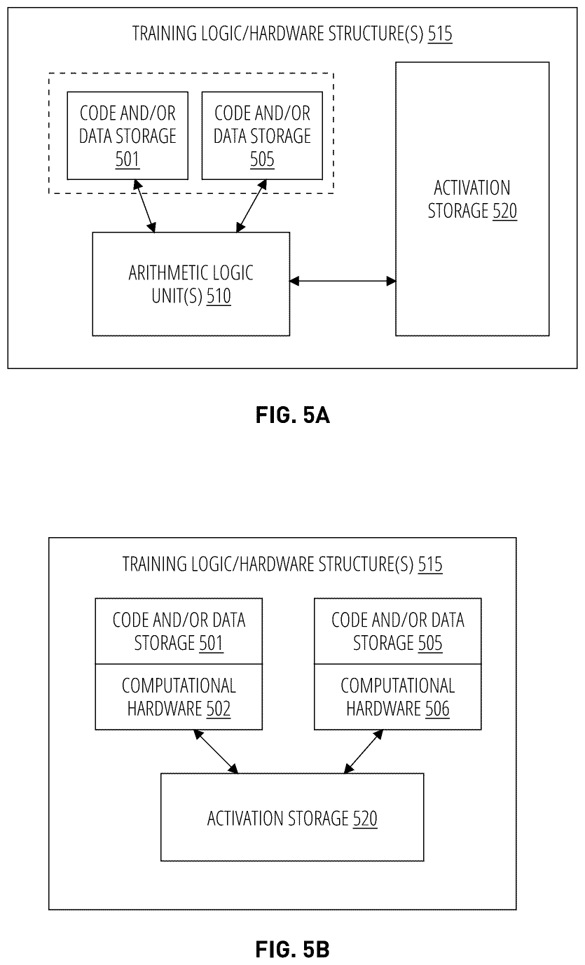

FIG. 5A illustrates inference and/or training logic 515 used to perform inferencing and/or training operations associated with one or more embodiments.

In at least one embodiment, inference and/or training logic 515 may include, without limitation, code and/or data storage 501 to store forward and/or output weight and/or input/output data, and/or other parameters to configure neurons or layers of a neural network trained and/or used for inferencing in aspects of one or more embodiments. In at least one embodiment, training logic 515 may include (or be coupled to code and/or data storage 501 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 501 may be included with other on-chip or off-chip data storage, including a processor's L1, L2, or L3 cache or system memory.

In at least one embodiment, any portion of code and/or data storage 501 may be internal or external to one or more processors or other hardware logic devices or circuits. In at least one embodiment, code and/or data storage 501 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 501 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a code and/or data storage 505 to store backward and/or output weight and/or input/output data corresponding to neurons or layers of a neural network trained and/or used for inferencing in aspects of one or more embodiments. In at least one embodiment, code and/or data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 515 may include (or be coupled to code and/or data storage 505 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 505 may be included with other on-chip or off-chip data storage, including a processor's L1, L2, or L3 cache or system memory. In at least one embodiment, any portion of code and/or data storage 505 may be internal or external to one or more processors or other hardware logic devices or circuits. In at least one embodiment, code and/or data storage 505 may be cache memory, DRAM, SRAM, non-volatile memory (e.g., flash memory), or other storage. In at least one embodiment, a choice of whether code and/or data storage 505 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or code and/or data storage 501 and code and/or data storage 505 may be separate storage structures. In at least one embodiment, code and/or data storage 501 and code and/or data storage 505 may be a combined storage structure. In at least one embodiment, code and/or data storage 501 and code and/or data storage 505 may be partially combined and partially separate. In at least one embodiment, any portion of code and/or data storage 501 and code and/or data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 520 that are functions of input/output and/or weight parameter data stored in code and/or data storage 501 and/or code and/or data storage 505. In at least one embodiment, activations stored in activation storage 520 are generated according to linear algebraic and/or matrix-based mathematics performed by ALU(s) 510 in response to performing instructions or other code, wherein weight values stored in code and/or data storage 505 and/or code and/or data storage 501 are used as operands along with other values, such as bias values, gradient information, momentum values, or other parameters or hyperparameters, any or all of which may be stored in code and/or data storage 505 or code and/or code and/or data storage 501 or another storage on or off-chip.

In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALU(s) 510 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 501, code and/or data storage 505, and activation storage 520 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., flash memory), or other storage. In at least one embodiment, activation storage 520 may be completely or partially within or external to one or more processors or other logical circuits. In at least one embodiment, a choice of whether activation storage 520 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 illustrated in FIG. 5A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, code and/or data storage 501 and code and/or data storage 505, which may be used to store code (e.g., graph code), weight values and/or other information, including bias values, gradient information, momentum values, and/or other parameter or hyperparameter information. In at least one embodiment illustrated in FIG. 5B, each of code and/or data storage 501 and code and/or data storage 505 is associated with a dedicated computational resource, such as computational hardware 502 and computational hardware 506, respectively. In at least one embodiment, each of computational hardware 502 and computational hardware 506 comprises one or more ALUs that perform mathematical functions, such as linear algebraic functions, only on information stored in code and/or data storage 501 and code and/or data storage 505, respectively, the result of which is stored in activation storage 520.

In at least one embodiment, each of code and/or data storage 501 and 505 and corresponding computational hardware 502 and 506, respectively, correspond to different layers of a neural network, such that resulting activation from one storage/computational pair 501/502 of code and/or data storage 501 and computational hardware 502 is provided as an input to a next storage/computational pair 505/506 of code and/or data storage 505 and computational hardware 506, in order to mirror a conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage/computation pairs 501/502 and 505/506 may be included in inference and/or training logic 515.

### Neural Network Training and Deployment

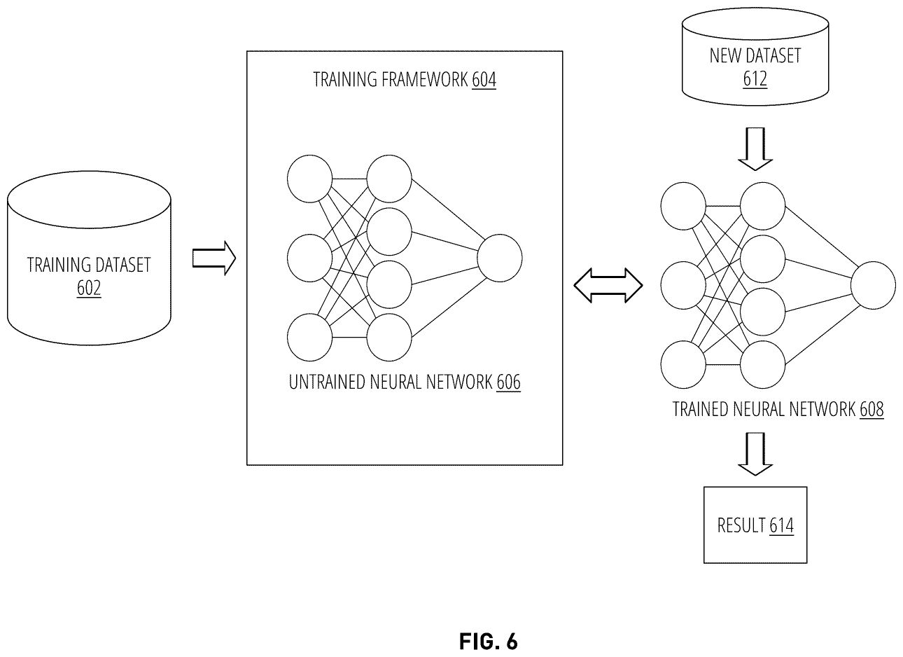

FIG. 6 illustrates training and deployment of a deep neural network, according to at least one embodiment. In at least one embodiment, untrained neural network 606 is trained using a training dataset 602. In at least one embodiment, training framework 604 is a PyTorch framework, whereas in other embodiments, training framework 604 is a TensorFlow, Boost, Caffe, Microsoft Cognitive Toolkit/CNTK, MXNet, Chainer, Keras, Deeplearning4j, or other training framework. In at least one embodiment, training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having a known output and an output of neural network 606 is manually graded. In at least one embodiment, untrained neural network 606 is trained in a supervised manner and processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on input data such as a new dataset 612. In at least one embodiment, training framework 604 trains untrained neural network 606 repeatedly while adjusting weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map in trained neural network 608 capable of performing operations useful in reducing dimensionality of new dataset 612. In at least one embodiment, unsupervised training can also be used to perform anomaly detection, which allows identification of data points in new dataset 612 that deviate from normal patterns of new dataset 612.

In at least one embodiment, semi-supervised learning may be used, which is a technique in which training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new dataset 612 without forgetting knowledge instilled within trained neural network 608 during initial training.

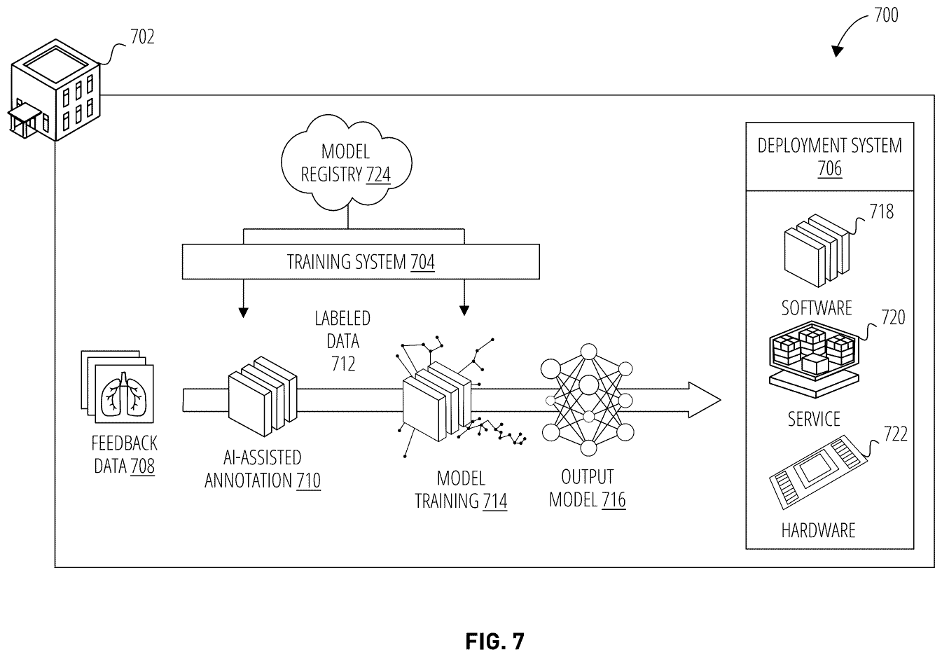

With reference to FIG. 7, FIG. 7 is an example data flow diagram for a process 700 of generating and deploying a processing and inferencing pipeline, according to at least one embodiment. In at least one embodiment, process 700 may be deployed to perform game name recognition analysis and inferencing on user feedback data at one or more facilities 702, such as a data center.

In at least one embodiment, process 700 may be executed within a training system 704 and/or a deployment system 706. In at least one embodiment, training system 704 may be used to perform training, deployment, and embodiment of machine learning models (e.g., neural networks, object detection algorithms, computer vision algorithms, etc.) for use in deployment system 706. In at least one embodiment, deployment system 706 may be configured to offload processing and compute resources among a distributed computing environment to reduce infrastructure requirements at facility 702. In at least one embodiment, deployment system 706 may provide a streamlined platform for selecting, customizing, and implementing virtual instruments for use with computing devices at facility 702. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 706 during execution of applications.

In at least one embodiment, some applications used in advanced processing and inferencing pipelines may use machine learning models or other AI to perform one or more processing steps. In at least one embodiment, machine learning models may be trained at facility 702 using feedback data 708 (such as imaging data) stored at facility 702 or feedback data 708 from another facility or facilities, or a combination thereof. In at least one embodiment, training system 704 may be used to provide applications, services, and/or other resources for generating working, deployable machine learning models for deployment system 706.

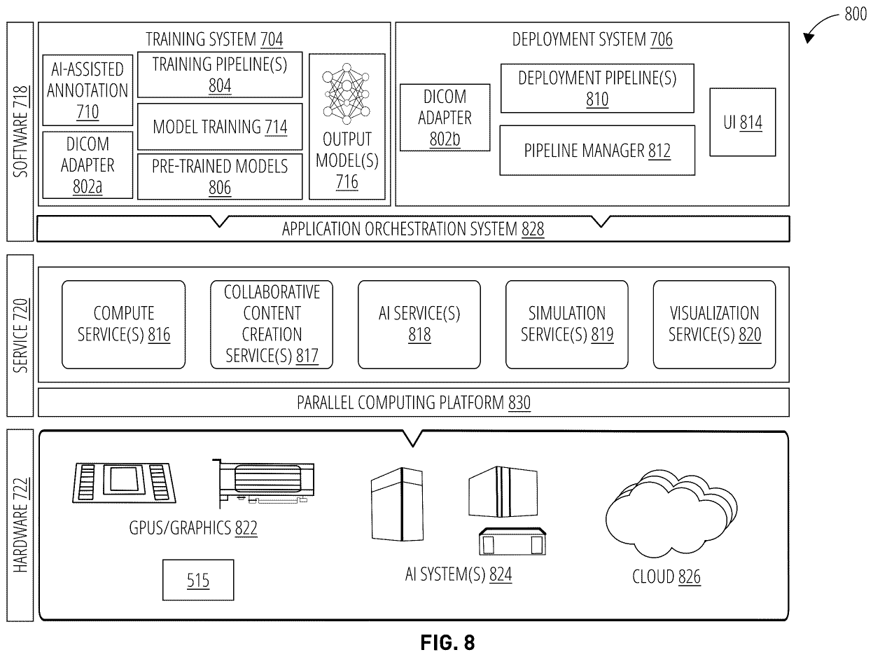

In at least one embodiment, a model registry 724 may be backed by object storage that may support versioning and object metadata. In at least one embodiment, object storage may be accessible through, for example, a cloud storage (e.g., a cloud 826 of FIG. 8) compatible application programming interface (API) from within a cloud platform. In at least one embodiment, machine learning models within model registry 724 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline(s) 804 (FIG. 8) may include a scenario where facility 702 is training their own machine learning model or has an existing machine learning model that needs to be optimized or updated. In at least one embodiment, feedback data 708 may be received from various channels, such as forums, web forms, or the like. In at least one embodiment, once feedback data 708 is received, AI-assisted annotation 710 may be used to aid in generating annotations corresponding to feedback data 708 to be used as ground truth data for a machine learning model. In at least one embodiment, AI-assisted annotation 710 may include one or more machine learning models (e.g., convolutional neural networks (CNNs)) that may be trained to generate annotations corresponding to certain types of feedback data 708 (e.g., from certain devices) and/or certain types of anomalies in feedback data 708. In at least one embodiment, AI-assisted annotations 710 may then be used directly, or may be adjusted or fine-tuned using an annotation tool, to generate ground truth data. In at least one embodiment, in some examples, labeled data 712 may be used as ground truth data for training a machine learning model. In at least one embodiment, AI-assisted annotations 710, labeled data 712, or a combination thereof may be used as ground truth data for training a machine learning model, e.g., via model training 714 in FIG. 7 and/or FIG. 8. In at least one embodiment, a trained machine learning model may be referred to as an output model 716, and may be used by deployment system 706, as described herein.

In at least one embodiment, training pipeline(s) 804 (FIG. 8) may include a scenario where facility 702 needs a machine learning model for use in performing one or more processing tasks for one or more applications in deployment system 706, but facility 702 may not currently have such a machine learning model (or may not have a model that is optimized, efficient, or effective for such purposes). In at least one embodiment, an existing machine learning model may be selected from model registry 724. In at least one embodiment, model registry 724 may include machine learning models trained to perform a variety of different inference tasks on imaging data. In at least one embodiment, machine learning models in model registry 724 may have been trained on imaging data from different facilities than facility 702 (e.g., facilities that are remotely located). In at least one embodiment, machine learning models may have been trained on imaging data from one location, two locations, or any number of locations. In at least one embodiment, when being trained on imaging data, which may be a form of feedback data 708, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained - or partially trained - at one location, a machine learning model may be added to model registry 724. In at least one embodiment, a machine learning model may then be retrained, or updated, at any number of other facilities, and a retrained or updated model may be made available in model registry 724. In at least one embodiment, a machine learning model may then be selected from model registry 724—and referred to as output model(s) 716—and may be used in deployment system 706 to perform one or more processing tasks for one or more applications of a deployment system.

In at least one embodiment, training pipeline(s) 804 (FIG. 8) may be used in a scenario that includes facility 702 requiring a machine learning model for use in performing one or more processing tasks for one or more applications in deployment system 706, but facility 702 may not currently have such a machine learning model (or may not have a model that is optimized, efficient, or effective for such purposes). In at least one embodiment, a machine learning model selected from model registry 724 might not be fine-tuned or optimized for feedback data 708 generated at facility 702 because of differences in populations, genetic variations, robustness of training data used to train a machine learning model, diversity in anomalies of training data, and/or other issues with training data. In at least one embodiment, AI-assisted annotation 710 may be used to aid in generating annotations corresponding to feedback data 708 to be used as ground truth data for retraining or updating a machine learning model. In at least one embodiment, labeled data 712 may be used as ground truth data for training a machine learning model. In at least one embodiment, retraining or updating a machine learning model may be referred to as model training 714. In at least one embodiment, model training 714 may include data—e.g., AI-assisted annotations 710, labeled data 712, or a combination thereof—that may be used as ground truth data for retraining or updating a machine learning model.

In at least one embodiment, deployment system 706 may include software 718, service 720, hardware 722, and/or other components, features, and functionality. In at least one embodiment, deployment system 706 may include a software “stack,” such that software 718 may be built on top of service 720 and may use service 720 to perform some or all of processing tasks, and service 720 and software 718 may be built on top of hardware 722 and use hardware 722 to execute processing, storage, and/or other compute tasks of deployment system 706.

In at least one embodiment, software 718 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 708 (or other data types, such as those described herein). In at least one embodiment, an advanced processing and inferencing pipeline may be defined based on selections of different containers that are desired or required for processing feedback data 708, in addition to containers that receive and configure imaging data for use by each container and/or for use by facility 702 after processing through a pipeline (e.g., to convert outputs back to a usable data type for storage and display at facility 702). In at least one embodiment, a combination of containers within software 718 (e.g., that make up a pipeline) may be referred to as a virtual instrument (as described in more detail herein), and a virtual instrument may leverage service 720 and hardware 722 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 716 of training system 704.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 724 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 720 as a system (e.g., system 800 of FIG. 8). In at least one embodiment, once validated by system 800 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 800 of FIG. 8). In at least one embodiment, completed and validated applications or containers may be stored in a container registry and associated machine learning models may be stored in model registry 724. In at least one embodiment, a requesting entity that provides an inference or image processing request may browse a container registry and/or model registry 724 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 706 (e.g., a cloud) to perform processing of a data processing pipeline. In at least one embodiment, processing by deployment system 706 may include referencing selected elements (e.g., applications, containers, models, etc.) from a container registry and/or model registry 724. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, service 720 may be leveraged. In at least one embodiment, service 720 may include compute services, collaborative content creation services, simulation services, artificial intelligence (AI) services, visualization services, and/or other service types. In at least one embodiment, service 720 may provide functionality that is common to one or more applications in software 718, so functionality may be abstracted to a service that may be called upon or leveraged by applications. In at least one embodiment, functionality provided by service 720 may run dynamically and more efficiently, while also scaling well by allowing applications to process data in parallel, e.g., using a parallel computing platform 830 (FIG. 8). In at least one embodiment, rather than each application that shares a same functionality offered by a service 720 being required to have a respective instance of service 720, service 720 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 720 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 718 implementing advanced processing and inferencing pipeline may be streamlined because each application may call upon the same inference service to perform one or more inferencing tasks.

In at least one embodiment, hardware 722 may include GPUs, CPUs, data processing units (DPUs), an AI/deep learning system (e.g., an AI supercomputer, such as NVIDIA's DGX™ supercomputer system), a cloud platform, or a combination thereof. In at least one embodiment, different types of hardware 722 may be used to provide efficient, purpose-built support for software 718 and service 720 in deployment system 706. In at least one embodiment, use of GPU processing may be implemented for processing locally (e.g., at facility 702), within an AI/deep learning system, in a cloud system, and/or in other processing components of deployment system 706 to improve efficiency, accuracy, and efficacy of game name recognition.

In at least one embodiment, software 718 and/or service 720 may be optimized for GPU processing with respect to deep learning, machine learning, and/or high-performance computing, simulation, and visual computing, as non-limiting examples. In at least one embodiment, at least some of the computing environment of deployment system 706 and/or training system 704 may be executed in a datacenter or one or more supercomputers or high performance computing systems, with GPU-optimized software (e.g., hardware and software combination of NVIDIA's DGX™ system). In at least one embodiment, hardware 722 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 8 is a system diagram for an example system 800 for generating and deploying a deployment pipeline, according to at least one embodiment. In at least one embodiment, system 800 may be used to implement process 700 of FIG. 7 and/or other processes including advanced processing and inferencing pipelines. In at least one embodiment, system 800 may include training system 704 and deployment system 706. In at least one embodiment, training system 704 and deployment system 706 may be implemented using software 718, services 720, and/or hardware 722, as described herein.

In at least one embodiment, system 800 (e.g., training system 704 and/or deployment system 706) may implemented in a cloud computing environment (e.g., using cloud 826). In at least one embodiment, system 800 may be implemented locally with respect to a facility, or as a combination of both cloud and local computing resources. In at least one embodiment, access to APIs in cloud 826 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 800, may be restricted to a set of public internet service providers (ISPs) that have been vetted or authorized for interaction.

In at least one embodiment, various components of system 800 may communicate between and among one another using any of a variety of different network types, including but not limited to local area networks (LANs) and/or wide area networks (WANs) via wired and/or wireless communication protocols. In at least one embodiment, communication between facilities and components of system 800 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 704 may execute training pipelines 804, similar to those described herein with respect to FIG. 7. In at least one embodiment, where one or more machine learning models are to be used in deployment pipeline(s) 810 by deployment system 706, training pipeline(s) 804 may be used to train or retrain one or more (e.g., pre-trained) models, and/or implement one or more of pre-trained models 806 (e.g., without a need for retraining or updating). In at least one embodiment, as a result of training pipeline(s) 804, output model(s) 716 may be generated. In at least one embodiment, training pipeline(s) 804 may include any number of processing steps, AI-assisted annotation 710, labeling or annotating of feedback data 708 to generate labeled data 712, model selection from a model registry, model training 714, training, retraining, or updating models, and/or other processing steps. In at least one embodiment, DICOM adapter 802a can be used to access DICOM data. In at least one embodiment, for different machine learning models used by deployment system 706, different training pipeline(s) 804 may be used. In at least one embodiment, training pipeline(s) 804, similar to a first example described with respect to FIG. 7, may be used for a first machine learning model, training pipeline(s) 804, similar to a second example described with respect to FIG. 7, may be used for a second machine learning model, and training pipeline(s) 804, similar to a third example described with respect to FIG. 7, may be used for a third machine learning model. In at least one embodiment, any combination of tasks within training system 704 may be used depending on what is required for each respective machine learning model. In at least one embodiment, one or more of machine learning models may already be trained and ready for deployment so machine learning models may not undergo any processing by training system 704 and may be implemented by deployment system 706.

In at least one embodiment, output model(s) 716 and/or pre-trained models 806 may include any types of machine learning models depending on embodiment. In at least one embodiment, and without limitation, machine learning models used by system 800 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 804 may include AI-assisted annotation. In at least one embodiment, labeled data 712 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 708 (or other data type used by machine learning models), there may be corresponding ground truth data generated by training system 704. In at least one embodiment, AI-assisted annotation may be performed as part of deployment pipeline(s) 810; either in addition to, or in lieu of, AI-assisted annotation included in training pipeline(s) 804. In at least one embodiment, system 800 may include a multi-layer platform that may include a software layer (e.g., software 718) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 702. In at least one embodiment, applications may then call or execute one or more services 720 for performing compute, AI, or visualization tasks associated with respective applications, and software 718 and/or services 720 may leverage hardware 722 to perform processing tasks in an effective and efficient manner.

In at least one embodiment, deployment system 706 may execute deployment pipelines 810. In at least one embodiment, deployment pipeline(s) 810 may include any number of applications that may be sequentially, non-sequentially, or otherwise applied to feedback data (and/or other data types), including AI-assisted annotation, as described above. In at least one embodiment, as described herein, a deployment pipeline(s) 810 for an individual device may be referred to as a virtual instrument for a device. In at least one embodiment, for a single device, there may be more than one deployment pipeline(s) 810 depending on information desired from data generated by a device.

In at least one embodiment, applications available for deployment pipeline(s) 810 may include any application that may be used for performing processing tasks on feedback data or other data from devices. In at least one embodiment, because various applications may share common image operations, in some embodiments, a data augmentation library (e.g., as one of services 720) may be used to accelerate these operations. In at least one embodiment, to avoid bottlenecks of conventional processing approaches that rely on CPU processing, parallel computing platform 830 may be used for GPU acceleration of these processing tasks.

In at least one embodiment, deployment system 706 may include a user interface (UI) 814 (e.g., a graphical user interface, a web interface, etc.) that may be used to select applications for inclusion in deployment pipeline(s) 810, arrange applications, modify or change applications or parameters or constructs thereof, use and interact with deployment pipeline(s) 810 during set-up and/or deployment, and/or to otherwise interact with deployment system 706. In at least one embodiment, although not illustrated with respect to training system 704, UI 814 (or a different user interface) may be used for selecting models for use in deployment system 706, for selecting models for training, or retraining, in training system 704, and/or for otherwise interacting with training system 704.

In at least one embodiment, pipeline manager 812 may be used, in addition to an application orchestration system 828, to manage interaction between applications or containers of deployment pipeline(s) 810 and services 720 and/or hardware 722. In at least one embodiment, pipeline manager 812 may be configured to facilitate interactions from application to application, from application to service 720, and/or from application or service to hardware 722. In at least one embodiment, although illustrated as included in software 718, this is not intended to be limiting, and in some examples pipeline manager 812 may be included in services 720. In at least one embodiment, application orchestration system 828 (e.g., Kubernetes, DOCKER, etc.) may include a container orchestration system that may group applications into containers as logical units for coordination, management, scaling, and deployment. In at least one embodiment, by associating applications from deployment pipeline(s) 810 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 812 and application orchestration system 828. In at least one embodiment, so long as an expected input and/or output of each container or application is known by a system (e.g., based on constructs of applications or containers), application orchestration system 828 and/or pipeline manager 812 may facilitate communication among and between, and sharing of resources among and between, each of the applications or containers. In at least one embodiment, because one or more of applications or containers in deployment pipeline(s) 810 may share the same services and resources, application orchestration system 828 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 828) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 720 leveraged and shared by applications or containers in deployment system 706 may include compute service(s) 816, collaborative content creation service(s) 817, AI service(s) 818, simulation service(s) 819, visualization service(s) 820, and/or other service types. In at least one embodiment, applications may call (e.g., execute) one or more of services 720 to perform processing operations for an application. In at least one embodiment, compute service(s) 816 may be leveraged by applications to perform super-computing or other high-performance computing (HPC) tasks. In at least one embodiment, compute service(s) 816 may be leveraged to perform parallel processing (e.g., using a parallel computing platform 830) for processing data through one or more of applications and/or one or more tasks of a single application, substantially simultaneously. In at least one embodiment, parallel computing platform 830 (e.g., NVIDIA's CUDA^{®}) may enable general purpose computing on GPUs (GPGPU) (e.g., GPUs/graphics 822). In at least one embodiment, a software layer of parallel computing platform 830 may provide access to virtual instruction sets and parallel computational elements of GPUs, for execution of compute kernels. In at least one embodiment, parallel computing platform 830 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 830 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 818 may be leveraged to perform inferencing services for executing machine learning model(s) associated with applications (e.g., tasked with performing one or more processing tasks of an application). In at least one embodiment, AI service(s) 818 may leverage AI system(s) 824 to execute machine learning model(s) (e.g., neural networks, such as CNNs) for segmentation, reconstruction, object detection, feature detection, classification, and/or other inferencing tasks. In at least one embodiment, applications of deployment pipeline(s) 810 may use one or more of output model(s) 716 from training system 704 and/or other models of applications to perform inference on imaging data (e.g., DICOM data, RIS data, CIS data, REST compliant data, RPC data, raw data, etc.). For example, DICOM adapter 802b may be used to access DICOM data. In at least one embodiment, two or more examples of inferencing using application orchestration system 828 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 828 may distribute resources (e.g., services 720 and/or hardware 722) based on priority paths for different inferencing tasks of AI service(s) 818.

In at least one embodiment, shared storage may be mounted to AI service(s) 818 within system 800. In at least one embodiment, shared storage may operate as a cache (or other storage device type) and may be used to process inference requests from applications. In at least one embodiment, when an inference request is submitted, a request may be received by a set of API instances of deployment system 706, and one or more instances may be selected (e.g., for best fit, for load balancing, etc.) to process a request. In at least one embodiment, to process a request, a request may be entered into a database, a machine learning model may be located from model registry 724 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 812) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 720 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 826, and an inference service may perform inferencing on a GPU.

In at least one embodiment, visualization service(s) 820 may be leveraged to generate visualizations for viewing outputs of applications and/or deployment pipeline(s) 810. In at least one embodiment, GPUs/graphics 822 may be leveraged by visualization service(s) 820 to generate visualizations. In at least one embodiment, rendering effects, such as ray-tracing or other light transport simulation techniques, may be implemented by visualization service(s) 820 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 820 may include an internal visualizer, cinematics, and/or other rendering or image processing capabilities or functionality (e.g., ray tracing, rasterization, internal optics, etc.).

In at least one embodiment, hardware 722 may include GPUs/graphics 822, AI system(s) 824, cloud 826, and/or any other hardware used for executing training system 704 and/or deployment system 706. In at least one embodiment, GPUs/graphics 822 (e.g., NVIDIA's TESLA® and/or QUADRO® GPUs) may include any number of GPUs that may be used for executing processing tasks of compute service(s) 816, collaborative content creation service(s) 817, AI service(s) 818, simulation service(s) 819, visualization service(s) 820, other services, and/or any of features or functionality of software 718. For example, with respect to AI service(s) 818, GPUs/graphics 822 may be used to perform pre-processing on imaging data (or other data types used by machine learning models), post-processing on outputs of machine learning models, and/or to perform inferencing (e.g., to execute machine learning models). In at least one embodiment, cloud 826, AI system(s) 824, and/or other components of system 800 may use GPUs/graphics 822. In at least one embodiment, cloud 826 may include a GPU-optimized platform for deep learning tasks. In at least one embodiment, AI system(s) 824 may use GPUs, and cloud 826—or at least a portion tasked with deep learning or inferencing—may be executed using one or more AI system(s)s 824. As such, although hardware 722 is illustrated as discrete components, this is not intended to be limiting, and any components of hardware 722 may be combined with, or leveraged by, any other components of hardware 722.

In at least one embodiment, AI system(s) 824 may include a purpose-built computing system (e.g., a super-computer or an HPC) configured for inferencing, deep learning, machine learning, and/or other artificial intelligence tasks. In at least one embodiment, AI system(s) 824 (e.g., NVIDIA's DGX™) may include GPU-optimized software (e.g., a software stack) that may be executed using a plurality of GPUs/graphics 822, in addition to CPUs, RAM, storage, and/or other components, features, or functionality. In at least one embodiment, one or more AI system(s)s 824 may be implemented in cloud 826 (e.g., in a data center) for performing some or all of AI-based processing tasks of system 800.

In at least one embodiment, cloud 826 may include a GPU-accelerated infrastructure (e.g., NVIDIA's NGC™) that may provide a GPU-optimized platform for executing processing tasks of system 800. In at least one embodiment, cloud 826 may include an AI system(s) 824 for performing one or more of AI-based tasks of system 800 (e.g., as a hardware abstraction and scaling platform). In at least one embodiment, cloud 826 may integrate with application orchestration system 828 leveraging multiple GPUs to enable seamless scaling and load balancing between and among applications and services 720. In at least one embodiment, cloud 826 may be tasked with executing at least some of services 720 of system 800, including compute service(s) 816, AI service(s) 818, and/or visualization service(s) 820, as described herein. In at least one embodiment, cloud 826 may perform small and large batch inference (e.g., executing NVIDIA's TensorRT™), provide an accelerated parallel computing platform 830 (e.g., NVIDIA's CUDA®), execute application orchestration system 828 (e.g., KUBERNETES), provide a graphics rendering API and platform (e.g., for ray-tracing, 2D graphics, 3D graphics, and/or other rendering techniques to produce higher quality cinematics), and/or may provide other functionality for system 800. In at least one embodiment, parallel computing platform 830 may include an API.

In at least one embodiment, in an effort to preserve patient confidentiality (e.g., where patient data or records are to be used off-premises), cloud 826 may include a registry, such as a deep learning container registry. In at least one embodiment, a registry may store containers for instantiations of applications that may perform pre-processing, post-processing, or other processing tasks on patient data. In at least one embodiment, cloud 826 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors —for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
executing, by a processing unit, a first task with associated processor configuration requirements;
receiving a second task and a third task to be executed by the processing unit, wherein each of the second task and the third task has associated processor configuration requirements;
determining a first next task to execute by the processing unit based on a comparison of a current processor configuration of the processing unit with the processor configuration requirements of the second task and the third task, wherein the current processor configuration of the processing unit is based on the processor configuration requirements associated with the first task; and
providing the first next task to the processing unit for execution.

2. The method of claim 1, wherein the second task is received before the third task; and wherein the first next task is the third task.

3. The method of claim 2, further comprising:
receiving a fourth task to be executed by the processing unit, the fourth task having associated processor configuration requirements;
determining, among at least the second task and the fourth task, a second next task to execute by the processing unit based on a comparison of the processor configuration requirements of the third task with the processor configuration requirements of the second task and the fourth task; and
providing the second next task to the processing unit for execution.

4. The method of claim 1, wherein each of the second task and the third task has associated resource requirements; and wherein determining the next task to execute by the processing unit is further based on current resource availability of the processing unit and the resource requirements of the second task and the third task.

5. The method of claim 4, wherein the resource requirements of the second task comprise at least one of:
a thread block size of the second task;
a number of registers needed by the second task; or
a number of barriers needed by the second task.

6. The method of claim 1, wherein each of the second task and the third task has an associated program/shader; and wherein determining the next task to execute by the processing unit is further based on a current program/shader of the processing unit and the program/shader of the second task and the third task.

7. The method of claim 1, wherein the processor configuration requirements of the second task comprise a level 1 (L1) cache memory configuration.

8. A system comprising:
a parallel processing unit executing a first task with associated processor configuration requirements; and
a circuit, coupled to the parallel processing unit, to:
receive a second task and a third task to be executed by the parallel processing unit, wherein each of the second task and the third task has associated processor configuration requirements;
determine a first next task to execute by the parallel processing unit based on a comparison of a current processor configuration of the parallel processing unit with the processor configuration requirements of the second task and the third task, wherein the current processor configuration of the parallel processing unit is based on the processor configuration requirements associated with the first task; and
provide the first next task to the parallel processing unit for execution.

9. The system of claim 8, wherein the second task is received before the third task; and wherein the first next task is the third task.

10. The system of claim 9, wherein the circuit is further to:
receive a fourth task to be executed by the parallel processing unit, the fourth task having associated processor configuration requirements;
determine, among at least the second task and the fourth task, a second next task to execute by the parallel processing unit based on a comparison of the processor configuration requirements of the third task with the processor configuration requirements of the second task and the fourth task; and
provide the second next task to the parallel processing unit for execution.

11. The system of claim 8, wherein each of the second task and the third task has associated resource requirements; and wherein determining the next task to execute by the parallel processing unit is further based on current resource availability of the parallel processing unit and the resource requirements of the second task and the third task.

12. The system of claim 11, wherein the resource requirements of the second task comprise at least one of:
a thread block size of the second task;
a number of registers needed by the second task; or
a number of barriers needed by the second task.

13. The system of claim 8, wherein each of the second task and the third task has an associated program/shader; and wherein determining the next task to execute by the parallel processing unit is further based on a current program/shader of the parallel processing unit and the program/shader of the second task and the third task.

14. The system of claim 8, wherein the processor configuration requirements of the second task comprise a level 1 (L1) cache memory configuration.

15. A system comprising:
a first processor executing a first task with associated processor configuration requirements; and
a second processor, coupled to the first processor, to:
receive a second task and a third task to be executed by the first processor, wherein each of the second task and the third task has associated processor configuration requirements;
determine a first next task to execute by the first processor based on a comparison of a current processor configuration of the first processor with the processor configuration requirements of the second task and the third task, wherein the current processor configuration of the first processor is based on the processor configuration requirements associated with the first task; and
provide the first next task to the first processor for execution.

16. The system of claim 15, wherein the second task is received before the third task; and wherein the first next task is the third task.

17. The system of claim 16, wherein the second processor is further to:
receive a fourth task to be executed by the first processor, the fourth task having associated processor configuration requirements;
determine, among at least the second task and the fourth task, a second next task to execute by the first processor based on a comparison of the processor configuration requirements of the third task with the processor configuration requirements of the second task and the fourth task; and
provide the second next task to the second processor.

18. The system of claim 15, wherein each of the second task and the third task has associated resource requirements; and wherein determining the next task to execute by the first processor is further based on current resource availability of the first processor and the resource requirements of the second task and the third task.

19. The system of claim 18, wherein the resource requirements of the second task comprise at least one of:
a thread block size of the second task;
a number of registers needed by the second task; or
a number of barriers needed by the second task.

20. The system of claim 15, wherein each of the second task and the third task has an associated program/shader; and wherein determining the next task to execute by the first processor is further based on a current program/shader of the first processor and the program/shader of the second task and the third task.
